(19) United States
(12) Patent Application Publication
(10) Pub. No.: US 2012/0170814 A1
(43) Pub. Date: Jul. 5, 2012

(54) IMAGES OF CARS INTEGRATION SYSTEM AND METHOD

(75) Inventor: CHUANG-WEI TSENG, Tu-Cheng (TW)

(73) Assignee: HON HAI PRECISION INDUSTRY CO., LTD., Tu-Cheng (TW)

(21) Appl. No.: 13/217,254

(22) Filed: Aug. 25, 2011

(30) Foreign Application Priority Data
Dec. 30, 2010 (TW) 099147059

(51) Int. Cl. G06K 9/62

(52) U.S. Cl. 382/105

(57) ABSTRACT

A cloud server of a data center and method integrate images of cars. The cloud server analyzes an image to obtain a license plate number of the car and generates a keyword corresponding to the image. The cloud server of the data center receives a number input by a user from a client. The cloud server of the data center matches the input number with the keyword to search an image corresponding to the input number.

### BACKGROUND

1. Technical Field

The embodiments of the present disclosure relate to cloud computing technology, and particularly to an image integration system and a method for integrating images of cars via cloud computing.

2. Description of Related Art

More and more event data recorders (EDR), installed in cars, can capture images of other cars. However, because of the limited storage capacity of the EDR, each EDR can only store limited images (e.g., 10 hours worth of images). In such a case, a user cannot watch images of the car that were captured 5 days ago in the EDR. Furthermore, the images of cars captured by EDRs installed in different cars are not integrated. Hence, if two or more cars are involved in a traffic accident, a user cannot search the images of each of the two or more cars at the same time. A method to store and integrate the images of cars is desired by users.

### BRIEF DESCRIPTION OF THE DRAWINGS

FIG. 1 is a system view of one embodiment of an image integration system.

FIG. 2 is a block diagram of one embodiment of a cloud server included in FIG. 1.

FIG. 3 is a flowchart of one embodiment of an image integration method.

### DETAILED DESCRIPTION

The disclosure is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

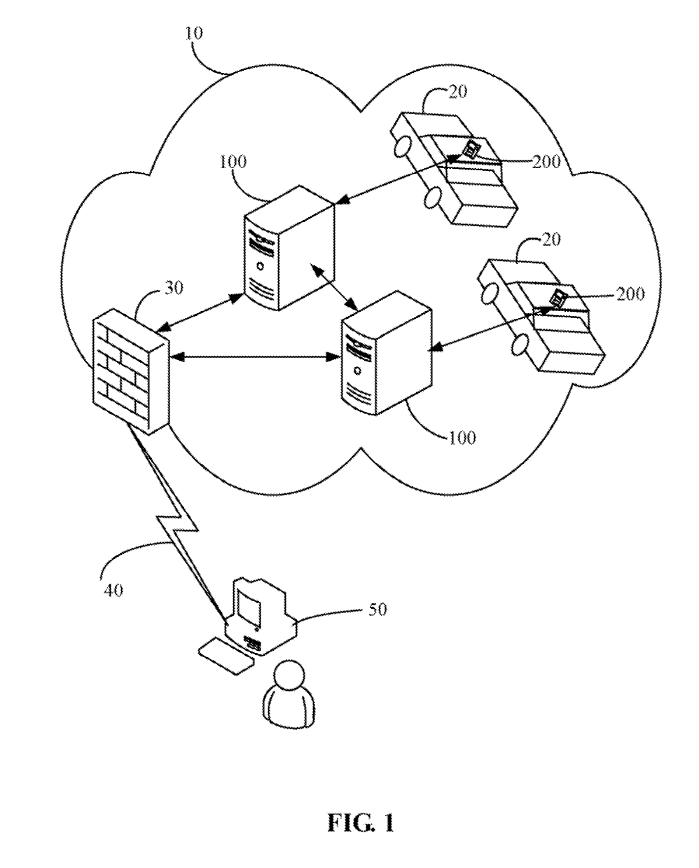

FIG. 1 is a block diagram of one embodiment of an image integration system 1. In one embodiment, the image integration system 1 may include a data center 10, a network 40 and one or more clients 50. The image integration system 1 may be used to integrate images of cars 20.

The data center 10 is located behind a firewall 30 and connected to the network 40. The network 40 may be, but is not limited to, a wide area network (e.g., the Internet) or a local area network. The firewall 30 protects the data center 10 from unauthorized access and secures data in the data center 10. The data center 10 is designed for cloud computing capability and capacity and includes a plurality of cloud servers 100. The cloud servers 100 are connected to the one or more cars 20 wirelessly.

Each car 20 is installed with an event data recorder (EDR) 200. The EDR 200 records information related to the cars 20, including visual information, especially when the car 20 has an accident (e.g., a crash). For example, the information may include whether brakes of the cars 20 were applied, a speed, a steering angle, and whether seat belts of the cars 20 were shown as “buckled” or “unbuckled” at the time of the crash. Additionally, the EDR 200 can capture an image of a car that is in front of or behind the EDR 200. For example, assuming that the two cars are labeled as A and B, then the EDR 200 of the car B may capture the image of the car A and send the image to the data center 10, and the EDR 200 of the car A may captures the images of the car B and sends the captured image to the data center 10. Each image includes a license plate number of the car 20. For example, the image of the car A includes the license plate number of the car A. Furthermore, the EDR 200 can also utilize infrared technology in order to capture images of the cars 20 at night.

The cloud server 100 is a dynamic host configuration protocol (DHCP) server. In one embodiment, the cloud server 100 assigns IP addresses to the client 50. The cloud server 100 may provide three modes for allocating IP addresses to the clients 50. The modes are dynamic allocation, automatic allocation, and static allocation. In one embodiment, the cloud server 100 uses dynamic allocation to assign the IP addresses to the clients 50. The cloud server 100 further sets a password (e.g., 123456$) and a name (e.g., apple) for enabling the client 50 to access the data center 10. The cloud server 100 also provides an access privilege for each client 50 according to the assigned IP address and the name. Additionally, the cloud server 100 may be a personal computer (PC), a network server, or any other item of data-processing equipment. Further details of the cloud server 10 will be described below.

The client 50 is electronically connected to the network 40. Additionally, the client 50 provides a user interface on the display for a user to access the data center 10 to control one or more operations of the cloud server 100. For example, the user may input a password and name by an input device (e.g., a keyboard) into the user interface on the display to access the data center 10. The client 50 may be, but is not limited to, a personal computer (PC), a network server, a mobile phone, a tablet computer, or any item of other data-processing equipment

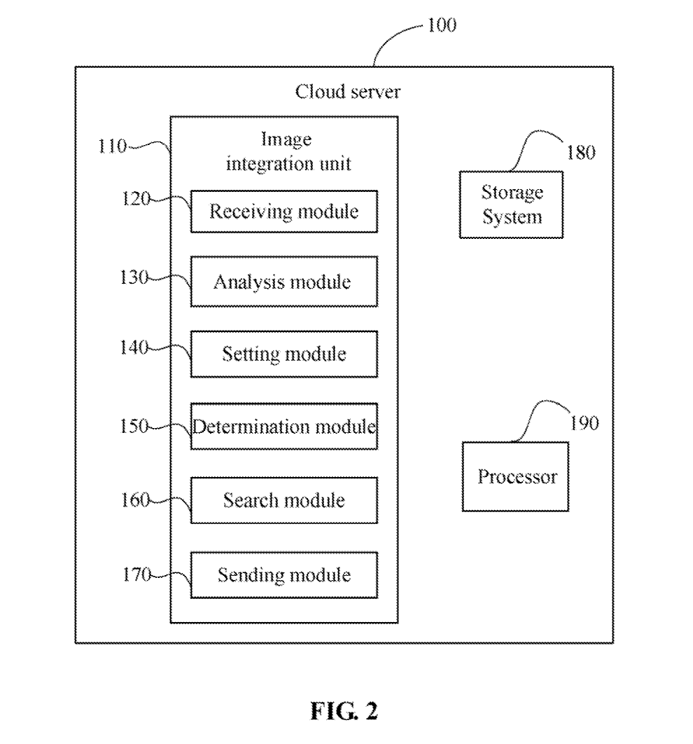

FIG. 2 is a block diagram of one embodiment of the cloud server 100 including an image integration unit 110. In one embodiment, the cloud server 100 further includes a storage system 180, and at least one processor 190. The image integration unit 110 includes a receiving module 120, an analysis module 130, a setting module 140, a verification module 150, a search module 160, and a sending module 170. The modules 120-170 may include computerized code in the form of one or more programs that are stored in the storage system 180. The computerized code includes instructions that are executed by the at least one processor 190 to provide functions for the modules 120-170. The storage system 180 may be a cache or a memory, such as an EPROM, HDD, or flash memory.

The receiving module 120 receives an image from an EDR 200 of the car 20 and saves the image into the storage system 180. In one embodiment, the EDR 200 installed in the car 20 may capture the image, and the receiving module 120 receives image from the EDR 200.

The analysis module 130 analyzes the image to obtain the license plate number of the car 20 in the image and generates a keyword corresponding to the image. In one embodiment, the license plate number is posted on a license plate of the car 20, and the license plate is located at a fixed position (e.g., the rear of the car 20). When the EDR 200 captures the image, the license plate number is located at a fixed position in the image. The analysis module 130 finds the fixed position of the image of car 20, and analyzes the pixels of the image to determine the license plate number of the car 20.

The setting module 140 sets identification information to be used in order to access the cloud server 100 of the data center 10 and assigns the identification information to the client 50. In one embodiment, the identification information includes the name, the password, and the IP address of the client 50. The identification information of each client 50 is also stored in the storage system 180.

The receiving module 120 receives a login request to access the cloud server 100 of the data center 10 from the client 50. In one embodiment, the user inputs a name and a password in the user interface of the client 50. The client 50 generates the login request and sends the login request to the cloud server 100 of the data center 10. It is understood that the login request is defined as a command having information of the input name, input password and the IP address of the client 50.

The determination module 140 determines if the client 50 is permitted to access the cloud server 100 of the data center 10. In one embodiment, the determination module 140 compares the identification information of the client 50 that is stored in the storage system 180 with information contained in the login request, if the identification information is the same as the information contained in the login request, the client 50 is permitted to access the cloud server 100 of the data center 10. Otherwise, if the identification information is different from the information contained in the login request, the client 50 is not permitted to the cloud server 100 of the data center 10.

The receiving module 120 further receives a number input by a user from the client 50, in response to a determination that the client is permitted to the cloud server 100 of the data center 10. The input number may be a license plate number. In one embodiment, the user inputs a license plate number in the user interface of the client 50. The client 50 sends the input license plate number to the cloud server 100 of the data center 10.

The search module 150 matches the input number with the keyword to search for an image corresponding to the input number from the storage system 180.

The sending module 160 sends searched image to the client 50 to notify the user. The image can be played on the display of the client 50 so that the user can view the EDR record of that particular car 20.

The denying module 170 denies the client 50 to access the cloud server 100 of the data center 10, in response to a determination that the client 50 is not permitted to access the cloud server 100 of the data center 10.

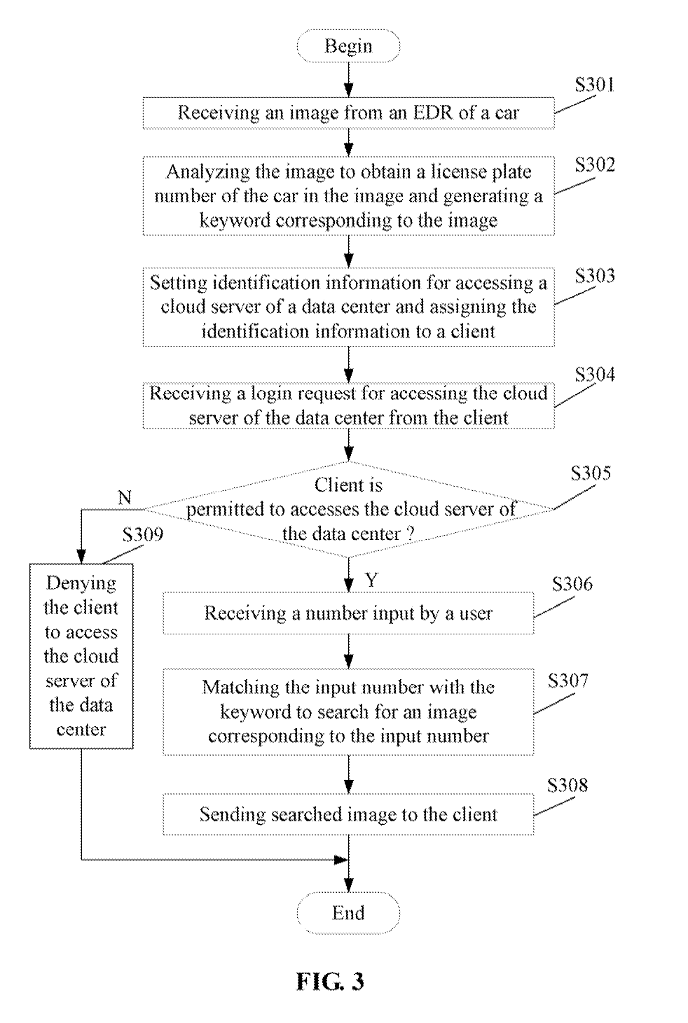

FIG. 3 is a flowchart of one embodiment of an image integration method. Depending on the embodiment, additional blocks may be added, others deleted, and the ordering of the blocks may be changed.

In block S301, the receiving module 120 receives an image from a EDR 200 of a car 20. In one embodiment, the receiving module 120 may receive the image from the EDR 200 at a time interval at which the image is captured. In one example, the receiving module 120 receives the image from the EDR 200 every hour.

In block S302, the analysis module 130 obtains a license plate number of the car 20 in the image and generates a keyword corresponding to the image. As mentioned above, for example, if the license plate number is “Amity123”, the pixels displaying parts of the “Amity123” in the image are different from the pixels of other parts in the image, and the analysis module 130 can search out the parts of the image showing license plate number “Amity123” by analyzing the pixels of the image. A user can use the keyword(s) to search for the image(s). For example, if the user inputs the keyword “Amity123,” the image of the car 20 which has “Amity123” as the license number can be searched out.

In block S303, the setting module 140 sets identification information to be used in order to access the cloud server 100 of the data center 10 and assigns the identification information to the client 50. As mentioned above, the identification information includes the name, the password, and the IP address of the client 50.

In block S304, the receiving module 120 receives a login request to access the cloud server 100 of the data center 10 from the client 50. As mentioned above, the user inputs a name and a password in the user interface of the client 50. The client 50 generates the login request and sends the login request to the cloud server 100 of the data center 10.

In block S305, the determination module 140 determines if the client 50 is permitted to access the cloud server 100 of the data center 10. If the identification information is different from the information contained in the login request, the client 50 is not permitted to the cloud server 100 of the data center 10, block S309 is implemented, the denying module 170 denies the client 50 to access the cloud server 100 of the data center 10. Then, the procedure ends. Otherwise, if the identification information is the same as the information contained in the login request, the client 50 is permitted to access the cloud server 100 of the data center 10, the procedure goes to block S306.

In block S306, the receiving module 120 further receives a number input by a user from the client 50, in response to a determination that the client is permitted to the cloud server 100 of the data center 10. As mentioned above, the user inputs a license plate number in the user interface of the client 50. The client 50 sends the input license plate number to the cloud server 100 of the data center 10.

In block S307, the search module 150 matches the input number with the keyword to search for an image corresponding to the input number. For example, if the input number is “Amity123”, the search module 150 searches an image that the key word is also “Amity123.”

In block S308, the sending module 160 sends searched image to the client 50. As mentioned above, the sending module 160 sends the image that the key word is also “Amity123” to the client 50 in order to play the image on the display of the client 50. The user can view the EDR record of that particular car 20.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A cloud server of a data center, comprising:
a storage system;
at least one processor; and
one or more programs stored in the storage system and being executable by the at least one processor, the one or more programs comprising:
a receiving module operable to receive an image from an event data recorder (EDR) of a car and save the received image into the storage system;
an analysis module operable to analyze the image to obtain a license plate number of the car in the image, and generate a keyword corresponding to the image according to the license plate number;
a receiving module operable to receive a number input by a user from a client in electronic communication with the cloud server; and
a search module operable to match the input number with the keyword to search for an image corresponding to the input number from the storage system.

2. The cloud server of the data center of claim 1, wherein the image is captured by the EDR of the car.

3. The cloud server of the data center of claim 1, wherein the keyword is the license plate number of the car.

4. The cloud server of the data center of claim 1, wherein the one or more programs further comprises a sending module operable to send searched image to the client to notify the user.

5. An image integration method implemented by a cloud server of a data center, the method comprising:
receiving an image from an event data recorder (EDR) of a car and saving received image into a storage system of the cloud server;
analyzing the image to obtain a license plate number of the car in the image and generating a keyword corresponding to the image according to the license plate number;
receiving a number input by a user from a client in electronic communication with the cloud server; and
matching the input number with the keyword to search for an image corresponding to the input number from the storage system of the cloud server.

6. The method of claim 5, wherein the image is captured by the EDR of the car.

7. The method of claim 5, wherein the keyword is the license plate number of the car.

8. The method of claim 5, further comprises:
sending searched image to the client to notify the user.

9. A non-transitory computer-readable medium having stored thereon instructions that, when executed by a cloud server, causing the cloud server to perform an image integration method, the method comprising:
receiving an image from an event data recorder (EDR) of a car and saving received image into a storage system of the cloud server;
analyzing the image to obtain a license plate number of the car in the image and generating a keyword corresponding to the image according to the license plate number;
receiving a number input by a user from a client in electronic communication with the cloud server; and
matching the input number with the keyword to search for an image corresponding to the input number from the storage system of the cloud server.

10. The medium of claim 9, wherein the image is captured by the EDR of the car.

11. The medium of claim 9, wherein the keyword is the license plate number of the car.

12. The medium of claim 9, further comprises:
sending searched image to the client to notify the user.
